(19) United States
(12) Patent Application Publication
(10) Pub. No.: US 2020/0016808 A1
(43) Pub. Date: Jan. 16, 2020

(54) METHOD FOR THE INJECTION MOLDING OF INTERNALLY HOLLOW PARTS

(71) Applicant: SAPA S.P.A., NAPOLI (NA) (IT)

(72) Inventor: Antonio AFFINITA, NAPOLI (NA) (IT)

(21) Appl. No.: 16/470,048

(22) PCT Filed: Dec. 19, 2017
(86) PCT No.: PCT/IT2017/050006

§ 371 Date: Jun. 14, 2019

(30) Foreign Application Priority Data
Dec. 21, 2016 (IT) 102016000129409

(51) Int. Cl. B29C 45/17

(52) U.S. Cl. CPC B29C 45/1711; B29C 45/37; B29C 45/1734; B29C 45/1732

(57) ABSTRACT

A method for the injection molding of internally hollow parts includes the steps of: injecting melt of thermoplastic material in the inner space between a punch and a matrix; opening a valve in order to place the inner space in communication with a secondary compartment; stopping the injection of the melt and opening a valve for supplying nitrogen in the inner space in order to create a cavity within the part being molded; stopping the supply of nitrogen and simultaneous perforation of the part being molded in the section of the connecting duct for the outflow of nitrogen from the mold and the subsequent possible collection thereof; and supplying pressurized air for washing towards the atmosphere after stopping the supply of nitrogen and the simultaneous perforation of the part being molded in the section of the connecting duct.

The present invention regards a method for the injection molding of internally hollow parts. This method provides for the injection of a thermoplastic melt from an injection unit along a flow path in an inner space of a mold, then the injection of a fluid in the plastic material still at the softened state, in a manner such that the plastic material is pressed against the walls of the inner space of the mold, then the cooling of the plastic material until a rigid part is formed, and finally the removal of the part from the inner space of the mold.

Among the prior art patents, U.S. Pat. No. 6,713,014 describes a process which is deemed the closest technique. According to U.S. Pat. No. 6,713,014, in the step of injecting the softened thermoplastic material, the inner space of the mold is not completely filled; in addition, the fluid injected in the inner space is a liquid with high thermal capacity, while a portion of the still-softened plastic material is moved from the inner space of the mold to a separate secondary compartment. The flow of the thermoplastic material from the inner space of the mold into the secondary cavity is controlled by means of a valve which is closed and opened according to the established timing.

The forming of the cavity inside the part can be achieved with a fluid which can be water or a gas under pressure, preferably nitrogen.

Nevertheless, nitrogen, which constitutes air, involves expenses for its separation and for its maintenance at low temperature.

DE 19505633 describes a process for making hollow parts of thermoplastic material which provides for the injection of the melt in the inner space of a mold and the simultaneous or successive injection of a pressurized fluid through one or more nozzles. Following the cooling, the fluid is released through one or more pressure-release nozzles separated from the fluid-injection nozzles. The fluid, preferably nitrogen, can be collected in a container and reused.

One object of the present finding is to reduce the quantity of pressurized nitrogen to a minimum, in order to reduce the costs of injection molding assisted by pressurized gas.

The abovementioned object and still others are attained by means of a method for the injection molding of internally hollow parts according to that claimed in the enclosed claims.

The present invention will now be described as a non-limiting example with reference to the enclosed drawings, in which:

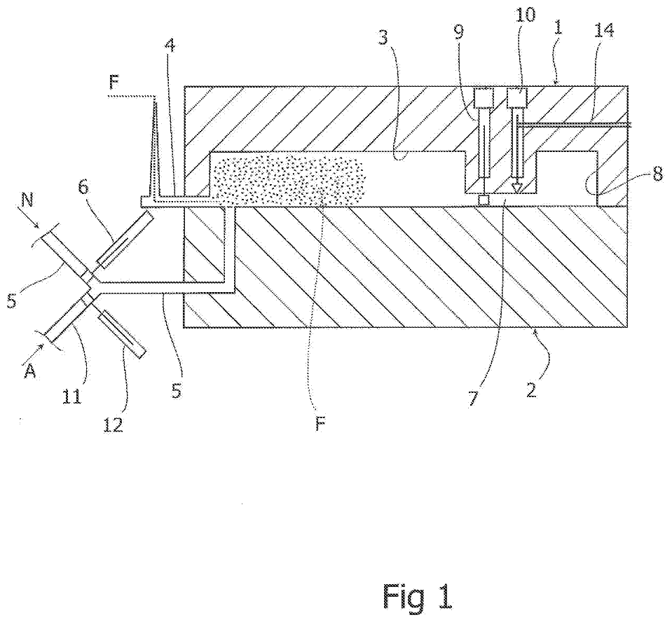

FIGS. 1 to 6 are schematic views of an apparatus which employs the method for the injection molding of internally hollow parts according to the present invention.

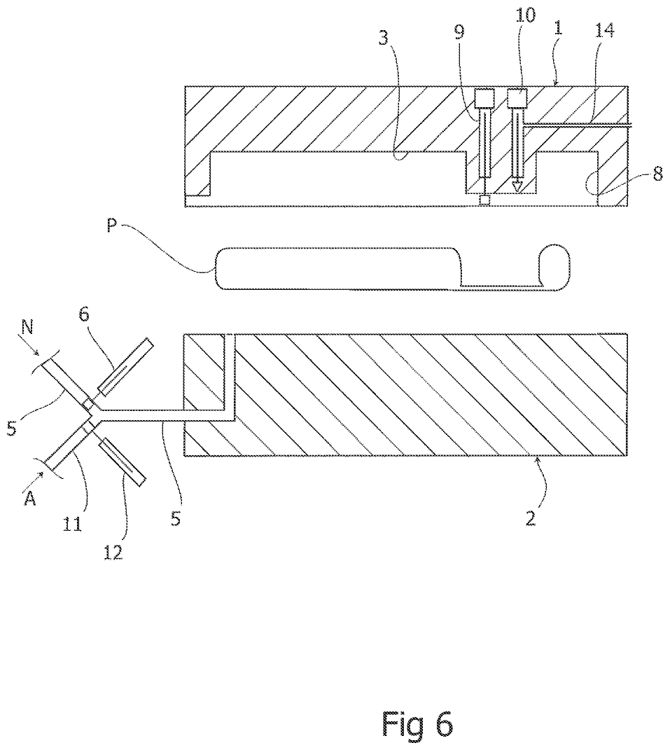

With reference to the figures, an apparatus is shown comprising a mold consisting of a matrix 1 and of a cooperating punch 2, both of which delimit inner space 3 which has the shape of the molded part indicated with P in FIG. 6. The inner space 3 communicates on one side with a nozzle 4 for the injection of thermoplastic material F and with a pressurized gas supplying pipe 5, i.e. nitrogen N from a tank of nitrogen and air A from an air tank. The tanks are not shown in the figures. The pipe 5 has a check valve, not shown, in its convergence with the inner space 3. Outside the mold, an air supply duct 11 converges into the pipe 5. In the pipe 5, a valve 6 for supplying nitrogen is inserted, while on the duct 11 a valve 12 for supplying air is inserted. There is also a connecting duct 7 which places the inner space 3 in communication with a secondary compartment 8 or created well, such as the inner space 3, between the matrix 1 and the punch 2. A valve 9 acts on the connecting duct 7 for the closure and opening thereof, and a perforating element 10 penetrates into the connecting duct 7.

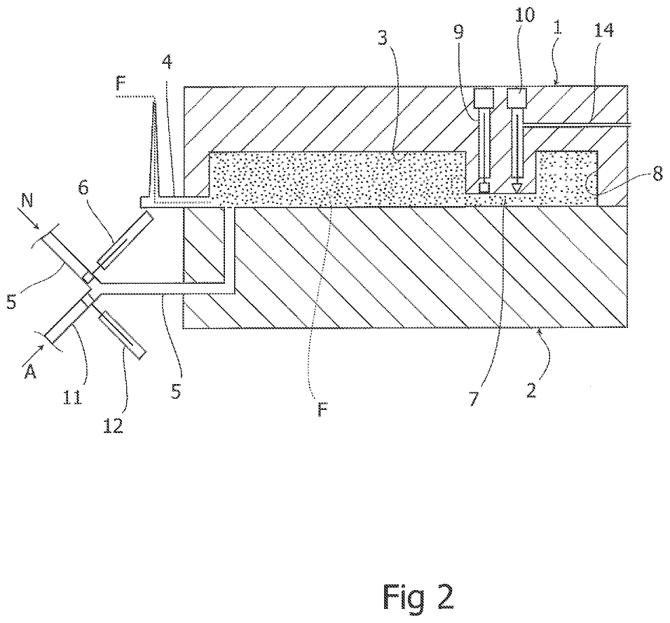

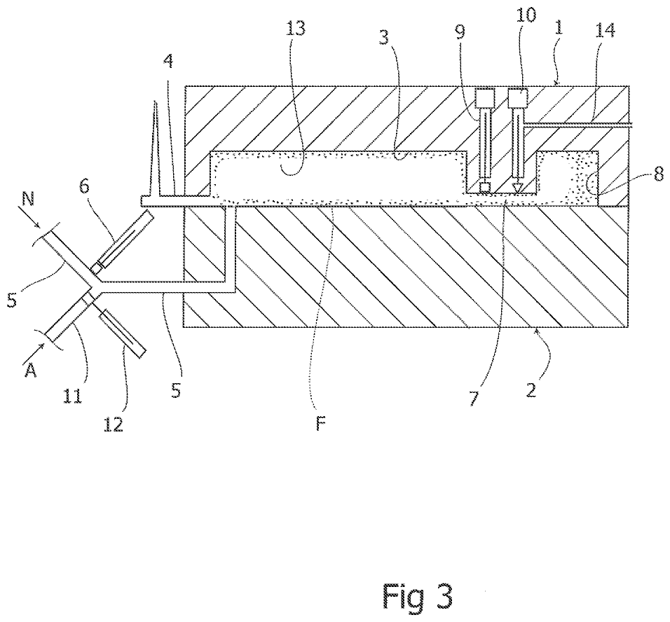

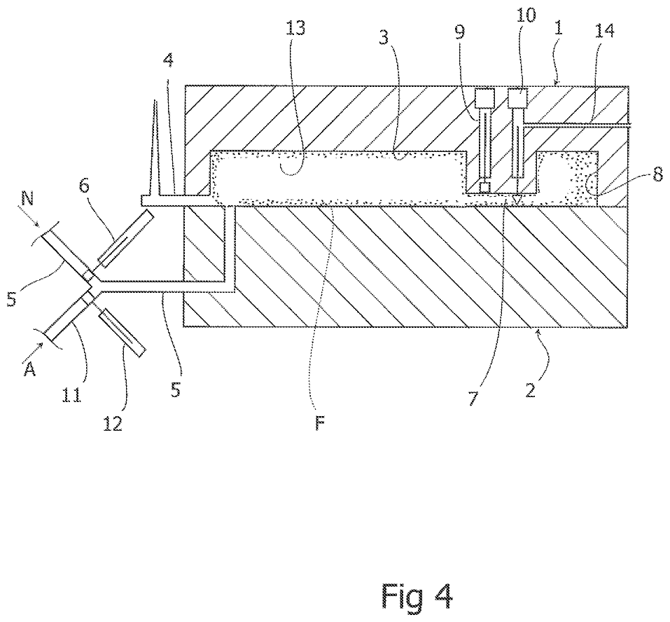

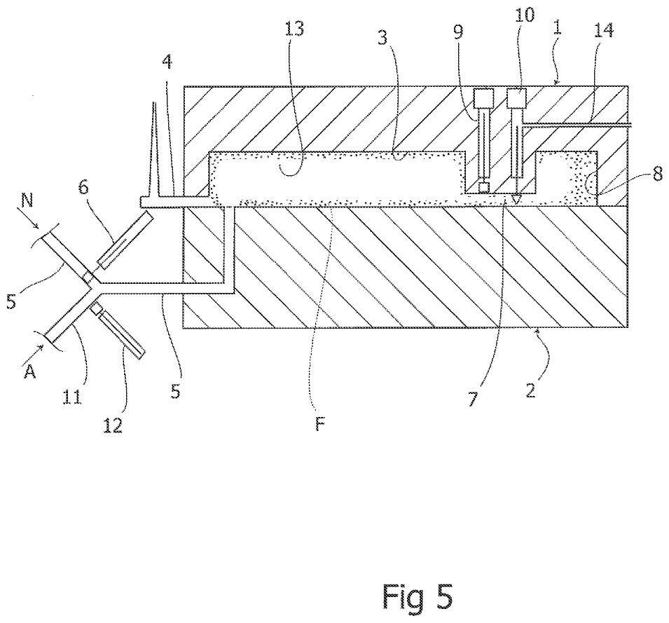

The method according to the invention comprises the injection in the inner space 3 (FIG. 1), the opening of the connecting duct 7 (FIG. 2), the supply of nitrogen in the inner space 3 for the formation of a cavity 13 in the part being molded (FIG. 3), the perforation of the part being molded in the section of the connecting duct 7 (FIG. 4), the venting of the cavity 13 created in the part being molded (FIG. 5), and the removal of the molded part P (FIG. 6).

For a description of the method according to the present invention ore detail, reference is made to FIG. 1. Through the nozzle 4, the injection of thermoplastic material F in the inner space 3 is activated, between the matrix 1 and the punch 2. The valve 6 for nitrogen and the valve 12 for air are closed. Also closed is the valve 9 for closing and opening the connecting duct 7 between the inner space 13 and the secondary compartment 8. As the injection progresses, the valve 9 is opened, as shown in FIG. 2.

In this manner, the thermoplastic material, after having completely occupied the inner space 3, passes through the connecting duct 7, into the secondary compartment 8. Before this step finishes, the valve 6 is opened and pressurized nitrogen is made to flow through the supply pipe 5; such pressurized nitrogen in the inner space 3 pushes the material still in the softened state towards the walls of the inner space 3 and into the connecting duet 7 up to the compartment 8. This step, also called emptying, leads to the formation of the cavity 13 inside the part P being molded.

At the end of the emptying, as shown in FIG. 4, the supply of pressurized nitrogen N is closed by means of the valve 6, and a perforation made in the hollow thermoplastic material situated in the connecting duct 7. The perforation is made by means of the perforating element 10 which allows the outflow of the pressurized nitrogen through a venting channel 14, with consequent possible recovery of the used nitrogen. The venting occurs via pressure difference since the gas supply pipe is inactive, given that the valve 6 for the nitrogen and the valve 12 for the air are closed.

Subsequently, there is a washing step by means of opening the valve 12 for air. Due to this opening, pressurized air is made to flow into the cavity 13 of the part P being molded. The opening of the air valve 12 makes pressurized air A flow through the air duet 11 in the cavity 13 of the part being molded P, cooling it. The air passes through the perforation previously created by means of the perforating element 10 in step 4 and exits outside the mold by means of a channel 14 passing through the perforating element 10. It must be clear that a two-way valve could be provided that switches the supply of nitrogen and air.

At the end of the washing step, the air valve 12 is closed, while the valve 6 of the nitrogen is closed and the valve 9 of the connecting duct is opened.

The extraction of the molded part P is shown in side view in FIG. 6. The punch 2 is moved away from the matrix 1. Of course, the gas supply is deactivated, and the supply of the thermoplastic melt is also deactivated.

The further finishing of the part P is not described.

It must be understood that the object of the invention is attained: the molding of internally hollow parts is enabled with considerable savings due to the combined use of pressurized air and nitrogen.

The protective scope of the invention is not limited to the preceding description, given only as an example, but is defined by the enclosed claims.

1. Method for the injection molding of internally hollow parts (P) by means of an apparatus comprising a mold consisting of a matrix (1) and a cooperating punch (2), both of which delimiting an inner space (3) communicating, on one side, with a nozzle (4) for the injection of melt (F) of thermoplastic material and with a pressurized gas supplying pipe (5), controlled by a first valve (6) for supplying nitrogen (N), and on the other side with a connecting duct (7) that places said inner space (3) in communication with a secondary compartment (8), a second valve (9) acting on the connecting duct (7) for the closure and opening thereof and a perforating element (10) that perforates a part (P) in the connecting duct (7), the method comprising the steps of:
injecting melt (F) of thermoplastic material in said inner space (3) between the punch (2) and matrix (1),
opening the second valve (9) in order to place said inner space (3) in communication with the secondary compartment (8),
stopping the injection of the melt (F) and opening the first valve (6) for supplying nitrogen (N) in said inner space (3) in order to create a cavity (13), until the passage of the nitrogen (N) in the secondary compartment (8),
stopping the supply of nitrogen (N) and simultaneously perforating the part (P) being molded in the section of the connecting duct (7) by means of the perforating element (10) for the outflow of nitrogen (N) from the mold and the subsequent possible collection thereof.
characterized in that it also comprises a supply (A) of pressurized air into said gas pipe (5) for washing towards the atmosphere after stopping the supply of nitrogen (N) and the simultaneous perforation of the part (P) being molded in the section of the connecting duct (7).

2. Method according to claim 1, wherein the pressurized air supply (A) is achieved through a supply duct (11) controlled by means of a third gas supply valve (12) and converging into said gas pipe (5).
